(19) United States
(12) Patent Application Publication
(10) Pub. No.: US 2005/0135803 A1
(43) Pub. Date: Jun. 23, 2005

(54) Gigabit ethernet passive optical network and method for accurately detecting data errors

(76) Inventors: Hak-Phil Lee, Incheon (KR); Se-Kang Park, Seongnam-si (KR)

Correspondence Address: CHA & REITER, LLC, 210 ROUTE 4 EAST STE 103, PARAMUS, NJ, 07652, US

(21) Appl. No.: 10/869,435

(22) Filed: Jun. 16, 2004

(30) Foreign Application Priority Data
Dec. 18, 2003 (KR) 2003-93276

(51) Int. Cl. G02F 1/00

(52) U.S. Cl. 398/1

(57) ABSTRACT

A Gigabit Ethernet passive optical network (GE-PON) and method for accurately detecting an error of data to securely transmit the data. The GE-PON comprises an optical line terminal (OLT) for performing first error checking of an Ethernet frame before encrypting original data content in the Ethernet frame, appending a first error detection code resulting from the first error checking to the Ethernet frame, encrypting the original data content, performing second error checking of the appended Ethernet frame containing the encrypted data, appending a second error detection code resulting from the second error checking to the appended Ethernet frame containing the encrypted data and transmitting the resulting Ethernet frame with the encrypted data, the first error correction code and the second error correction code to at least one destination, and at least one optical network terminal (ONT) for checking a transmission error of the received Ethernet frame containing the encrypted data, the first error correction code and the second error correction code transmitted from the OLT using the second error detection code, decrypting the encrypted data and checking an encryption error and decryption error of the resulting Ethernet frame with the decrypted data using the first error detection code.

### CLAIM OF PRIORITY

This application claims priority, pursuant to 35 U.S.C. §119, to that patent application entitled “GIGABIT ETHERNET PASSIVE OPTICAL NETWORK AND METHOD FOR ACCURATELY DETECTING ERROR OF DATA TO SECURELY TRANSMIT DATA,” filed in the Korean Intellectual Property Office on Dec. 18, 2003 and assigned Serial No. 2003-93276, the contents of which are hereby incorporated by reference.

### BACKGROUND OF THE INVENTION

1. Field of the Invention

The present invention relates to a Gigabit Ethernet passive optical network (GE-PON) and, more particularly, to a system and method for detecting errors occurring during data encryption/decryption and transmission.

2. Description of the Related Art

Nowadays, the expansion of public networks, including wireless networks, and very high-speed communication networks, enables mass data to be shared online. It is the current reality that the offline sharing of data through low-priced mass storage media, such as compact discs (CDs) or digital versatile discs (DVDs), is also used very widely. Therefore, users can be provided with numerous types of data shared online and/or offline.

Online/offline sharing systems are desirable as they readily provide a large amount of various data to users. But they have a vulnerable security structure for various types of commercial multimedia data, and data requiring high security.

A passive optical network (PON) is a communication network system that transfers signals to end users over an optical cable network. The PON typically consists of an optical line terminal (OLT) installed in a communication company and a plurality of optical network terminals (ONTs) installed near subscribe. Typically a maximum of 32 ONTs can be connected to a single OLT.

The PON can provide a bandwidth of 622 Mbps in the downstream direction and a bandwidth of 155 Mbps in the upstream direction in one stand-alone system, and these bandwidths can be allocated to a plurality of PON users. The PON may be used as a trunk between a large-scale system, such as a cable TV system, or an Ethernet network for a neighboring building or home employing a coaxial cable.

In the conventional PON, an OLT transmits a signal to an ONT via an optical cable. The ONT receives the signal transmitted from the OLT, processes it in a predetermined manner and then transfers the processed result to the end user. The ONT, which is a transfer system of the service subscriber side, is an optical network termination unit that provides a service interface to the end user.

The ONT may accommodate a plurality of different methods of transferring received data to the subscriber. For example, FTTC (Fiber To The Curb), FTTB (Fiber To The Building), FTTF (Fiber To The Floor), FTTH (Fiber To The Home), FTTO (Fiber To The Office), methods may all be used by the ONT. In using a fiber connection, the ONT is implemented to provide high service accessibility to the subscriber. The ONT functions typically includes a cable connect to transmit an analog signal to the subscriber and optical equipment to transmit and receive optical signals to and from the OLT. The ONT, in a downstream context, performs an optical/electrical conversion operation to convert an optical signal received from the OLT into an electrical signal and transmits the converted electrical signal to the subscriber and, in an upstream context, performs an electrical/optical conversion operation to convert an electrical signal from the subscriber into an optical signal and transmits the converted optical signal to the OLT.

FIG. 1 shows a downstream data transmission structure of a conventional Gigabit Ethernet passive optical network and FIG. 2 shows an upstream data transmission structure of the Gigabit Ethernet passive optical network As shown in FIGS. 1 and 2, the Gigabit Ethernet passive optical network (GE-PON) has a structure where one OLT 10 is connected with a plurality of ONTs 20, 22 and 24 in a tree form via an optical splitter 15. The GE-PON is an optical access network that is inexpensive and more efficient than an AON (Activity-On-Node) network.

In earlier versions of a GE-PON, an asynchronous transfer mode passive optical network (ATM-PON) has been developed and standardized. The ATM-PON transmits ATM cells in the form of a block with a desired size in the upstream or downstream direction. Alternatively, an Ethernet passive optical network (E-PON) has been developed that transmits packets of different sizes in the form of a block with a desired size. As a result, the E-PON has a somewhat complex control structure compared with the ATM-PON.

Downstream data transmission will now be described with reference to FIG. 1. In the downstream transmission, the OLT 10 broadcasts data to be transmitted to the ONTs 20, 22 and 24. The optical splitter 15 receives the data broadcast from the OLT 10 and transmits the received data to each of the ONTs 20, 22 and 24. The ONTs 20, 22 and 24 each detect data to be transferred to a corresponding one of users 30, 32 and 34 from the data transmitted from the optical splitter 15 and transfers only the detected data to the corresponding user 30, 32 or 34.

Upstream data transmission will now be described with reference to FIG. 2. In the upstream transmission, data from the users 30, 32 and 34 are transferred to the ONTs 20, 22 and 24, respectively. The ONTs 20, 22 and 24 transmit the data from the users 30, 32 and 34 to the optical splitter 15 according to a transmission permission convention from the OLT 10. The ONTs 20, 22 and 24 each transmit, upstream, the received data in an allocated time slot set in a TDM (Time Division Multiplexing) manner. Therefore, there is no data collision in the optical splitter 15 resulting from the upstream data transmission.

FIG. 3 shows the format of an Ethernet frame proposed in the IEEE 802.3ah standard. As shown, the 802.3ah Ethernet frame format is composed a wait time information, an Ethernet frame, which is effective information required for a destination, and error check information. The wait time and error check information are referred to as overhead as they are used by the system for management purposes.

The overhead preceding the Ethernet frame includes a wait time value and a preamble. The Ethernet frame includes a destination address (DA), a source address (SA), data length/type information, and actual data, i.e., content. The overhead following the Ethernet frame includes an error detection code for error checking of the Ethernet frame. In FIG. 3, a frame check sequence (FCS)/cyclic redundancy check (CRC) code is used as the error detection code.

In the present information society, communication services are strongly directed to the business side of producing value-added products, and communication service users want to sufficiently receive various services, such as voice, data, video and others, at any place or time through one terminal, rather than simply desiring to exchange voice and data with a counterpart. To this end, in many countries, including Korea, very high-speed communication networks are being constructed, satellite communication enterprises, such as an Iridium enterprise, are in progress, and research and development is being actively carried-out for multimedia communication, mobile communication, application software, etc. Further, in the information society, schemes to efficiently and reliably transmit and store digital data have become increasingly important, resulting in a need for a study of error control coding for design of a reliable data transmission system.

The study of error control coding started with an article, entitled “A Mathematical Theory of Communication”, published by C. E. Shannon in 1948. In this article, Shannon proposed a theory of introducing a probability concept in information to express the information as bits and transmit it errorlessly over noisy and noiseless channels. Since then, research has been actively conducted into encoding and decoding for error control in noisy environments, and the use of codes for the error control has become an essential factor to the design of communication systems and digital computers.

The error control codes can be classified into a block code and a convolutional code. The block code is used to provide an n-bit codeword for k-bit information. Such block codes can be classified into a linear code and a cyclic code. The convolutional code refers to a code whose output sequence is influenced by a previous input sequence, as well as a current input sequence.

The cyclic code was first discussed with a series of technical reports, published by E. P range, and evolved into a BCH code and Reed-Solomon code. Many research results for the cyclic code have been published because of abundant algebraic structures of the cyclic code, and the cyclic code has been widely used in various fields, such as CD players, Gigabit/sec-class high-speed communications and so forth, since an encoder and decoder can be simply implemented on the basis of a high-speed shift register.

Returning to the system shown in FIG. 1, The OLT 10 which transmits data and the ONTs 20, 22 and 24 which receive the transmitted data perform error detections on the data to be transmitted and the received data, respectively. An error detection method used here may be, for example, a CRC/FCS error detection method.

The CRC error detection method is an error detection method for verifying reliability of data in serial transmission. Such CRC error detection methods can be classified into a parity bit-based error detection method and a checksum-based error detection method. The parity bit-based error detection method cannot perform error detection when 2 bits or 4 bits of data change at a time. The checksum-based error detection method cannot detect errors when the errors occur as +1 in one byte and as −1 in the other byte. That is, the error detection probability of the CRC error detection method is low.

Because the parity bit-based error detection method and checksum-based error detection method provide no reliable error detection means for a burst error, a CRC method using a polynomial code has recently been used for data error detection. In this CRC method, a transmitter calculates an error detection code using the contents of a frame to be transmitted and inserts the calculated error detection code in the last portion of the frame, and a receiver receiving the frame, calculates an error detection code using the contents of the received frame in a similar manner and compares the calculated error detection code with the error detection code in the received frame to perform error detection. Here, the error detection code is referred to has an FCS or CRC code.

For the CRC calculation, a data set is a very long string (or message) composed of Is and Os. This binary string is divided by a fixed-size, small binary string, called a generator polynomial. The remainder of this binary division is a CRC checksum. With a generator polynomial selected according to specific mathematical features, it is possible to detect almost all errors in the message on the basis of the final checksum. The most powerful one of these generator polynomials makes it possible to detect one or two bit errors and all errors of consecutive erroneous bits whose length is an odd number. It is even further possible to detect up to 99.99% of burst errors (sequences of consecutive errors).

This CRC method secures high reliability, facilitates simple implementation of an encoder and decoder, requires a small overhead for error detection, and has very excellent performance in detecting errors including a random error or burst error.

The principle of the CRC method is that a transmitter appends the remainder of division as redundancy to the original data to be transmitted and transmits the resulting data, and a receiver divides the transmitted data with the redundancy by the original data and detects an error by checking whether the resulting remainder is 0. Here, the remainder is called an FCS, which is the important part of the CRC method. For CRC, the transmitter appends an error detection code, or FCS, to every data frame and transmits the resulting data frame, so that the receiver can detect an error of the transmitted frame.

In the CRC method, all calculations are made on the basis of binary numbers. That is, a transmitter and a receiver treat all data streams as binary polynomials. Given the original data frame, the transmitter generates an FCS for error detection of that frame. For generation of an FCS in the transmitter, there is a need for a CRC polynomial, which is a divisor for division. As stated previously, the remainder resulting from the division of a data frame to be transmitted by a CRC polynomial is an FCS.

The FCS is appended to the tail of the original data frame to be transmitted so that the resulting frame (the cascade of the original frame and the FCS) is exactly divisible by a predefined polynomial in the receiver. This predefined polynomial is called a divisor or CRC polynomial.

The receiver receives the resulting frame, and performs the CRC for the received frame in such a manner that it checks the remainder resulting from the division of the received frame by the same CRC polynomial as that used in the transmitter. If the remainder is not 0, the receiver determines that an error has occurred during the transmission.

However, there is no encryption-related packet format proposed in the IEEE 802.3ah standard.

FIGS. 4 and 5 show examples of conventional methods for encryption and error detection in Ethernet communication. FIG. 4 is illustrates a conventional method for encryption and error detection in Ethernet communication that checks for error of data before encrypting the data.

More specifically, OLT 10 checks for error of data using an error detection code, or FCS. As the data is in an unencrypted state, OLT 10 then disassembles the data from an Ethernet frame and encrypts it (step S11). Upon completion of the encryption of the disassembled data, OLT 10 reassembles the encrypted data with the Ethernet frame (step S13) and transmits the resulting frame to the ONTs 20, 22 and 24 (step S15).

The ONTs 20, 22 and 24 receive the Ethernet frame with the encrypted data and decrypt the encrypted data in the reverse order to that of the encryption by the OLT 10. That is, the ONTs 20, 22 and 24 disassemble the data from the received Ethernet frame and decrypt it (step S17). When the data decryption is completed, then the ONTs 20, 22 and 24 reassemble the decrypted data with the Ethernet frame. The ONTs 20, 22 and 24 then checks for an error of the Ethernet frame using an FCS contained in the tail of the Ethernet frame (step S19).

Where the error checking of the Ethernet frame is performed before data encryption, the receiver can detect FCS errors including errors occurring in the following three cases: an error during the encryption by the transmitter at step S11, an error during the transmission from the transmitter to the receiver at step S15, and an error during the decryption by the receiver at step S17. As a result, in the case where the error checking is performed before data encryption as shown in FIG. 4, there is a problem in that it is not possible to correct errors having occurred during the data encryption, data transmission and data decryption.

FIG. 5 is a flow chart illustrating a conventional method for encryption and error detection in Ethernet communication that checks an error of data after encrypting the data. In this case, the OLT 10 disassembles data from an Ethernet frame and encrypts it (step S21). After the OLT 10 completes the data encryption, then it reassembles the encrypted data with the Ethernet frame. At this time, the OLT 10 performs FCS error checking with respect to the encrypted data, a destination address (DA), a source address (SA) and data type/length information (step S23). Upon completion of the FCS error checking, the OLT 10 transmits the resulting Ethernet frame to destinations (S25).

The ONTs 20, 22 and 24, in this case, receive the Ethernet frame transmitted from the OLT 10 and perform the FCS error checking with respect to the encrypted data, DA, SA and data type/length information. When the ONTs 20, 22 and 24 complete the error checking, they disassemble the encrypted data from the Ethernet frame and decrypt it (step S27). Upon completing the data decryption, the ONTs 20, 22 and 24 reassemble the decrypted data with the Ethernet frame (step S29).

Where data is error-checked and transmitted after being encrypted, the receiver may detect an FCS error, which is an error having occurred during the transmission of the Ethernet frame at step S25. In the case where the receiver performs the error checking in this manner, there is a problem in that it cannot detect an error having occurred during the encryption by the transmitter and an error having occurred during the decryption by the receiver.

### SUMMARY OF THE INVENTION

Therefore, the present invention has been made in view of the above problems, and it is an object of the present invention to provide a Gigabit Ethernet passive optical network (GE-PON) and devices for enhancing error detection performance between one OLT and a plurality of ONTs to securely transmit and receive data, and a data error detection method using the same.

It is another object of the present invention to provide a GE-PON to detect and recover errors of an Ethernet frame which may occur during data encryption by a transmitter, data transmission from the transmitter to a receiver and data decryption by the receiver, to enable secure, encrypted Ethernet communication, and a data error detection method using the same.

In accordance with an aspect of the present invention, the above and other objects can be accomplished by the provision of a Gigabit Ethernet passive optical network (GE-PON) comprising an optical line terminal (OLT) for performing first error checking of an Ethernet frame before encrypting original data in the Ethernet frame, appending a first error detection code resulting from the first error checking to the Ethernet frame, encrypting the original data, performing a second error checking of the resulting Ethernet frame with the encrypted data, appending a second error detection code resulting from the second error checking to the Ethernet frame with the encrypted data and transmitting the resulting appended Ethernet frame containing the encrypted data, first error correction code and second error correction code to at least one destination, and at least one optical network terminal (ONT) for checking a transmission error of the Ethernet frame containing the encrypted data, the first error correction code and the second error correction code transmitted from the OLT using the second error detection code, decrypting the encrypted data and checking an encryption error and decryption error of the resulting Ethernet frame with the decrypted data using the first error detection code.

In one aspect, the OLT includes a first error detector, a frame disassembler, an encrypter, a frame reassembler and a second error detector. The first error detector performs the first error checking of the unencrypted Ethernet frame and appends the first error detection code resulting from the first error checking to the Ethernet frame. The Ethernet frame is composed of a destination address, a source address, data type/length information and the original data content.

The frame disassembler disassembles the original data from the Ethernet frame appended with the first error detection code. The encrypter encrypts the disassembled data from the frame disassembler using a predefined encryption algorithm and encryption key. The frame reassembler reassembles the encrypted data from the encrypter and the destination address, source address, data type/length information and first error correction code, from which the original data was disassembled by the frame disassembler, into a reassembled Ethernet frame.

The second error detector performs the second error checking of the reassembled Ethernet frame from the frame reassembler, appends the second error detection code resulting from the second error checking to the reassembled Ethernet frame and transmits the resulting Ethernet frame to the destination.

In one aspect, the ONT includes a transmission error detector, a frame disassembler, a decrypter, a frame reassembler and an encryption/decryption error detector. The transmission error detector checks the transmission error of the Ethernet frame with the encrypted data, first error correction code and second error correction code transmitted from the OLT using the second error detection code. The frame disassembler disassembles the encrypted data from the Ethernet frame, transmission error-checked by the transmission error detector. The decrypter decrypts the disassembled, encrypted data from the frame disassembler using a predefined decryption algorithm and decryption key. The frame reassembler reassembles the decrypted data and the Ethernet frame from which the encrypted data was disassembled by the frame disassembler.

The encryption/decryption error detector checks the encryption error and decryption error of the reassembled Ethernet frame from the frame reassembler using the first error detection code.

In accordance with another aspect of the present invention, there is provided a data error detection method for secure data transmission and reception between one OLT and at least one ONT in a GE-PON structure, comprising the steps of a) performing first error checking of an Ethernet frame before encrypting original data in the Ethernet frame, appending a first error detection code resulting from the first error checking to the Ethernet frame, encrypting the original data, performing second error checking of the resulting Ethernet frame with the encrypted data, appending a second error detection code resulting from the second error checking to the Ethernet frame with the encrypted data and transmitting the resulting Ethernet frame with the encrypted data, the appended first error correction code and the appended second error correction code to at least one destination and b) checking a transmission error of the Ethernet frame containing the encrypted data, the appended first error correction code and the appended second error correction code transmitted from the OLT using the second error detection code, decrypting the encrypted data and checking an encryption error and decryption error of the resulting Ethernet frame with the decrypted data using the first error detection code.

Preferably, the step a) includes the steps of: a-1) performing the first error checking of the Ethernet frame and appending the first error detection code as the result value of the first error checking to the Ethernet frame, the Ethernet frame being composed of a destination address, a source address, data type/length information and the original data, i.e., content, a-2) disassembling the original data from the Ethernet frame appended with the first error detection code, a-3) encrypting the disassembled data using a predefined encryption algorithm and encryption key, a-4) reassembling the encrypted data and the destination address, source address, data type/length information and first error correction code, from which the original data was disassembled, into a reassembled Ethernet frame; and a-5) performing the second error checking of the reassembled Ethernet frame, appending the second error detection code resulting from the second error checking to the reassembled Ethernet frame and transmitting the resulting Ethernet frame including the encrypted content, appended first and second detection codes to the destination.

Step b) includes the steps of b-1) checking the transmission error of the Ethernet frame with the encrypted data, first error correction code and second error correction code transmitted from the OLT using the second error detection code; b-2) disassembling the encrypted data from the transmission error-checked Ethernet frame; b-3) decrypting the disassembled, encrypted data using a predefined decryption algorithm and decryption key; b-4) reassembling the decrypted data and the Ethernet frame from which the encrypted data was disassembled; and b-5) checking the encryption error and decryption error of the reassembled Ethernet frame using the first error detection code.

In an aspect of the present invention, the transmitter checks errors of data before and after encrypting the data, respectively, and transmits the resulting data to a receiver, and the receiver receives the transmitted data and checks a transmission error of the received data using an error detection code, referred to as FCS2, a resultant value of the error checking after the data encryption, and an encryption error and decryption error of the received data using an error detection code, referred to as FCS1, a resultant value of the error checking before the data encryption. Therefore, it is possible to enhance data error detection performance to more securely transmit and receive data.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view showing a downstream data transmission structure of a Gigabit Ethernet passive optical network (GE-PON);

FIG. 2 is a view showing an upstream data transmission structure of the GE-PON;

FIG. 3 is a view showing the format of an Ethernet frame proposed in the IEEE 802.3ah standard;

FIGS. 4 and 5 illustrate process flows of conventional methods for encryption and error detection in Ethernet communication;

FIG. 6 is a block diagram showing an embodiment of a GE-PON according to the present invention; and

FIG. 7 is a flow chart illustrating an embodiment of a data error detection method using the GE-PON according to the present invention.

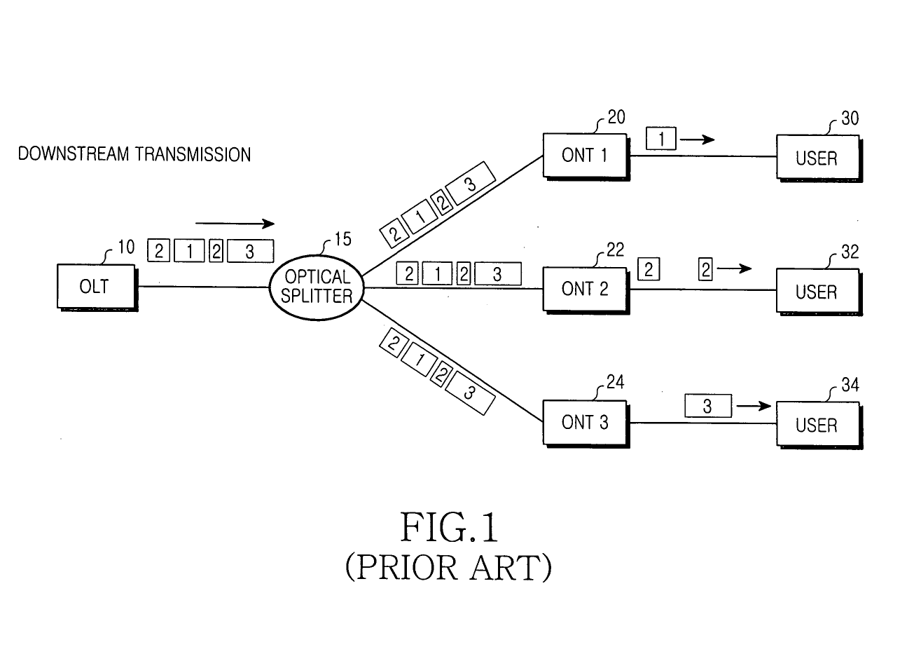

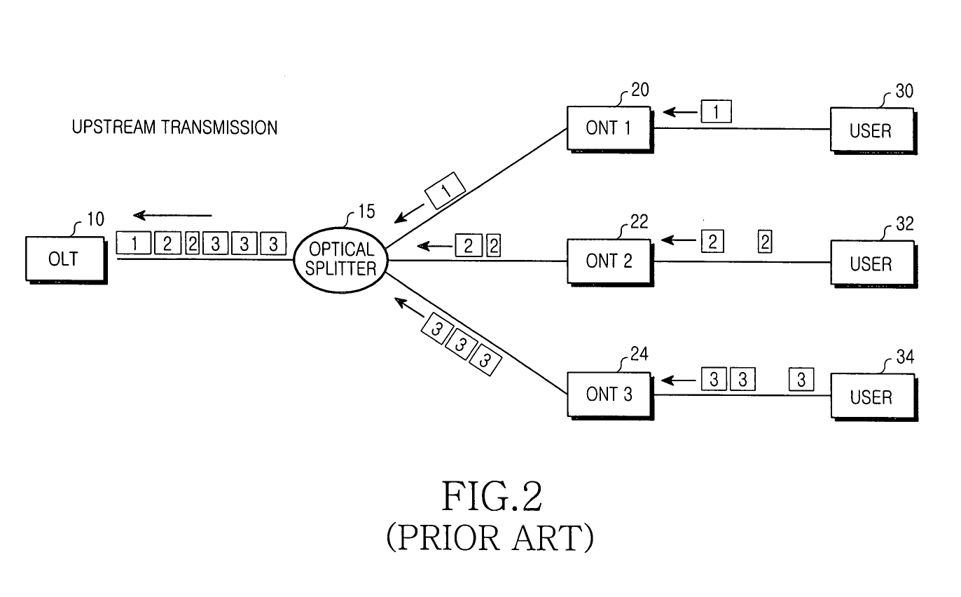

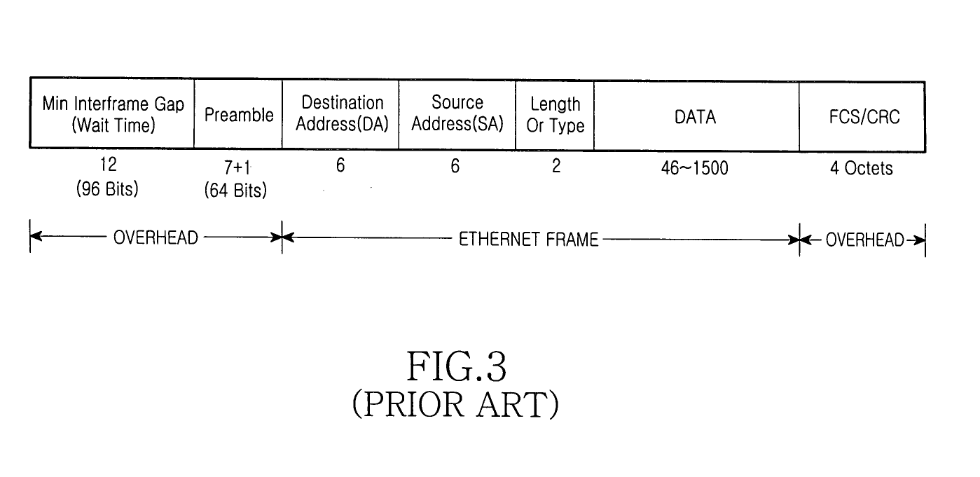

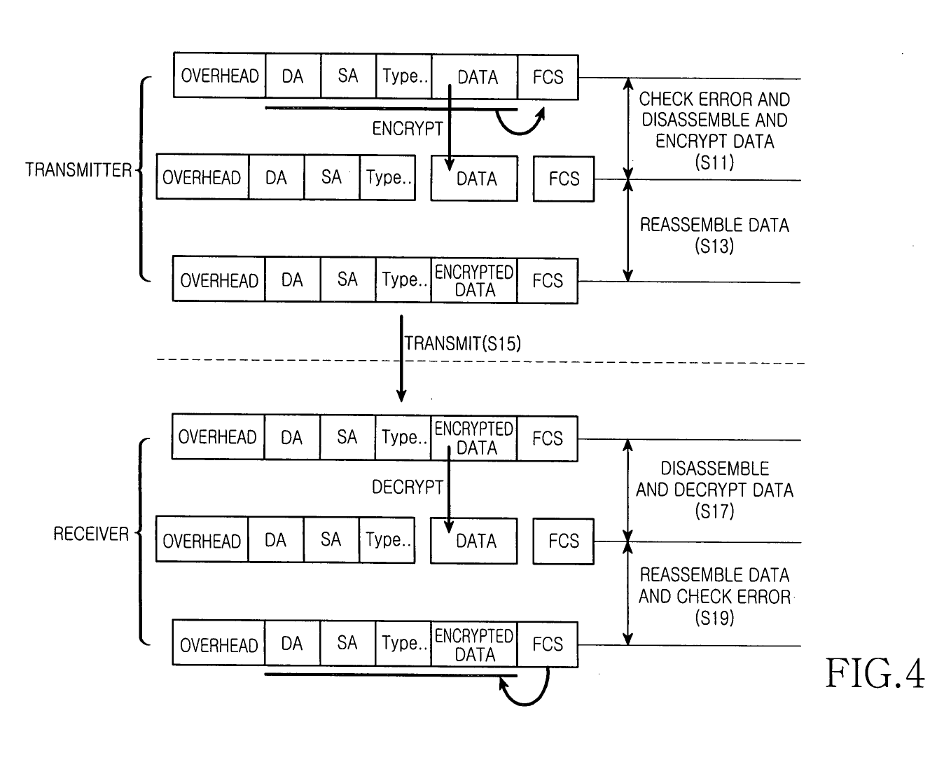

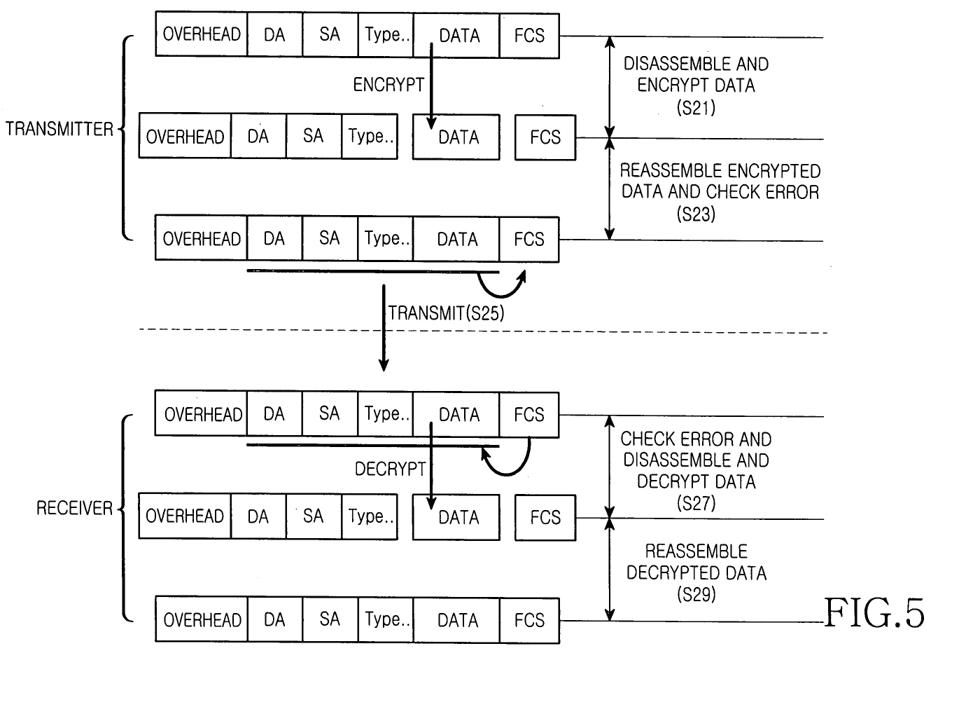

### DETAILED DESCRIPTION OF THE INVENTION

Embodiments of the present invention will now be described in detail with reference to the drawings. For purposes of clarity and simplicity, a detailed description of known functions and configurations incorporated herein will be omitted when it may make the subject matter of the present invention unclear.

A detailed description will now be given of a method for detecting an error of data to securely transmit and receive the data between one OLT and a plurality of ONTs in a GE-PON structure, according to the present invention. In this invention, data encryption in a GE-PON is applied to the entire data field of a GE-PON standard Ethernet frame.

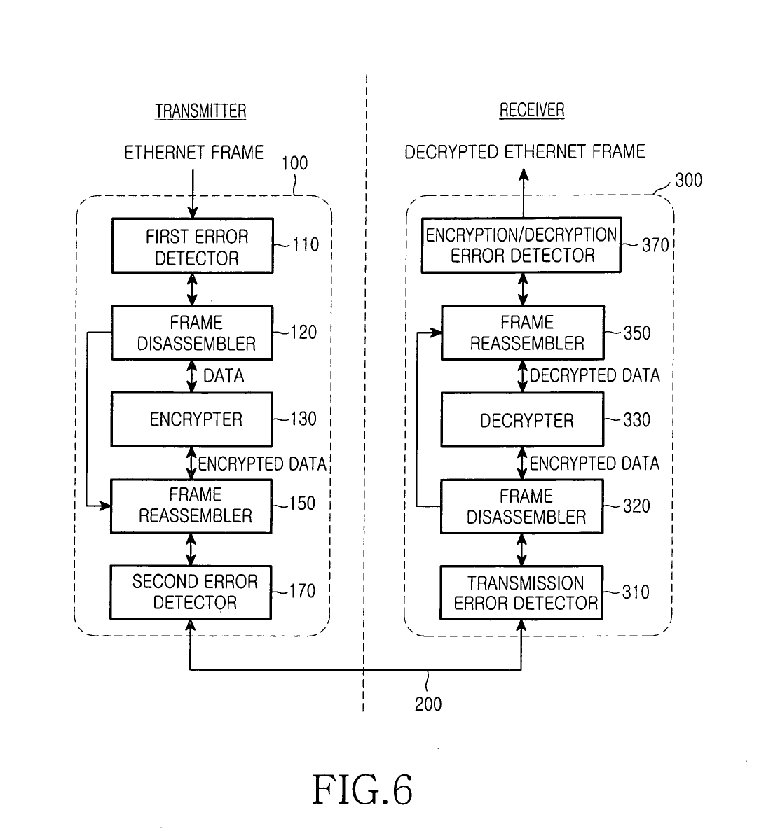

FIG. 6 is a block diagram showing an embodiment of a GE-PON which is capable of more accurately detecting an error of data to securely transmit data according to the present invention. For reference, in the present embodiment, data encryption is processed at a Gigabit Ethernet passive optical network media access control (GE-PON MAC) layer or a data link layer that is layer 2 of the seven layers of the open systems interconnection (OSI) communications model.

As shown, the GE-PON comprises an OLT 100 and at least one ONT 300 set up channels to each other via a transmission medium 200 and transmit and receive data over the set-up channels.

The OLT 100 includes a first error detector 110, a frame disassembler 120, an encrypter 130, a frame reassembler 150 and a second error detector 170. The first error detector 110 performs error checking of an unencrypted Ethernet frame composed of a destination address field, a source address field, a data type/length field and a data field containing original data content. The first error detector 110 then appends a resultant value of the error checking, FCS1, to the tail of the Ethernet frame and outputs the resulting frame to the frame disassembler 120.

The frame disassembler 120 disassembles data from the Ethernet frame appended with the FCS1. The frame disassembler 120 then outputs the disassembled data to the encrypter 130 and the Ethernet frame elements other than the disassembled data, i.e., the destination address field, source address field, data type/length field and FCS) to the frame reassembler 150, respectively.

The encrypter 130 encrypts the output data from the frame disassembler 120 using a predefined encryption algorithm and encryption key. When the encryption is completed, the encrypter 130 outputs the encrypted data to the frame reassembler 150.

The frame reassembler 150 reassembles the unencrypted destination address field, source address field, data type/length field and FCS1 from the frame disassembler 120 and the encrypted data from the encrypter 130 into a reassembled Ethernet frame. The frame reassembler 150 then outputs the reassembled Ethernet frame to the second error detector 170.

The second error detector 170 performs error checking of the Ethernet frame from the frame reassembler 150. The second error detector 170 appends a resultant value of the error checking, FCS2, to the tail of the Ethernet frame from the frame reassembler 150. The resulting Ethernet frame, appended with the FCS1 and FCS2 through this process, is transmitted to the ONT 300 via the transmission medium 200.

Upon receiving the Ethernet frame transmitted from the OLT 100, the ONT 300 performs error checking and data decryption with respect to the received Ethernet frame. To this end, the ONT 300 includes, as shown in FIG. 6, a transmission error detector 310, a frame disassembler 320, a decrypter 330, a frame reassembler 350 and an encryption/decryption error detector 370.

The transmission error detector 310 performs error checking of the received Ethernet frame with reference to the FCS2 thereof. That is, the transmission error detector 310 can detect an error having occurred during the transmission of the Ethernet frame with the encrypted data over the transmission channel 200 by performing the error checking of the Ethernet frame with reference to the FCS2. Upon completing the operation of detecting an error during the transmission of the Ethernet frame using the FCS2, the transmission error detector 310 outputs the encrypted data, destination address field, source address field, data type/length field and FCS1 of the Ethernet frame to the frame disassembler 320.

The frame disassembler 320 disassembles the encrypted data from the encrypted data, destination address field, source address field, data type/length field and FCS1 of the Ethernet frame from the transmission error detector 310. The frame disassembler 320 then outputs the disassembled, encrypted data to the decrypter 330 and the destination address field, source address field, data type/length field and FCS1 to the frame reassembler 350, respectively.

The decrypter 330 decrypts the encrypted data from the frame disassembler 320 using a predefined decryption algorithm and decryption key. As a result, the decrypter 330 outputs the decrypted data, or the original plaintext data prior to the encryption, to the frame reassembler 350.

The frame reassembler 350 reassembles the destination address field, source address field, data type/length field and FCS1 from the frame disassembler 320 and the decrypted data from the decrypter 330 into a reassembled Ethernet frame. The frame reassembler 350 then outputs the reassembled Ethernet frame to the encryption/decryption error detector 370.

The encryption/decryption error detector 370 performs error checking of the Ethernet frame from the frame reassembler 350 with reference to the FCS1 thereof. That is, the encryption/decryption error detector 370 can detect errors having occurred during the encryption and decryption of the data in the Ethernet frame by performing the error checking of the Ethernet frame with reference to the FCS1 thereof.

In summary, in accordance with the principles of the invention, a transmitter checks errors of data before and after encrypting the data, respectively, and transmits the resulting data to a receiver. Further, the receiver receives the transmitted data and checks a transmission error of the received data using an error detection code FCS2, a result value of the error checking after the data encryption, and an encryption error and decryption error of the received data using an error detection code FCS1, a result value of the error checking before the data encryption. Therefore, the GE-PON can enhance data error detection performance to more securely transmit and receive data.

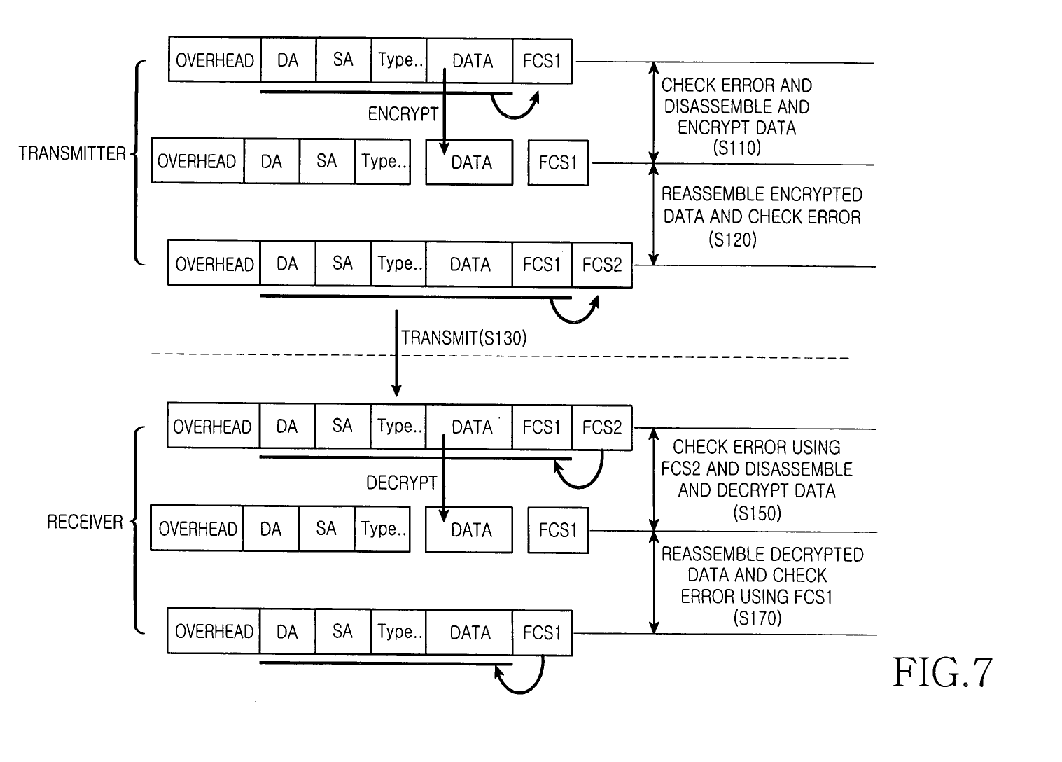

FIG. 7 illustrates a process flow in accordance with a preferred embodiment of a data error detection method using the GE-PON according to the present invention. First, upon receiving an unencrypted Ethernet frame composed of a destination address field, a source address field, a data type/length field and a data field, the first error detector 110 performs error checking of the received Ethernet frame. The first error detector 110 then appends a resultant value of the error checking, FCS1, to the tail of the Ethernet frame. The frame disassembler 120 disassembles data from the Ethernet frame appended with the FCS1. The encrypter 130 encrypts the data disassembled from the Ethernet frame using a predefined encryption algorithm and encryption key (step S10). When the encryption is completed, then the encrypter 130 outputs the encrypted data to the frame reassembler 150.

The frame reassembler 150 reassembles the unencrypted destination address field, source address field, data type/length field and FCS1 from which the data was disassembled by the frame disassembler 120, and the encrypted data content from the encrypter 130 into a reassembled Ethernet frame. The second error detector 170 performs error checking of the reassembled Ethernet frame (step S120).

The second error detector 170 then appends a resultant value of the error checking, FCS2, to the tail of the Ethernet frame from the frame reassembler 150. The Ethernet frame with the encrypted data, appended with the FCS1 and FCS2 through this process, is transmitted to the ONT 300 via the transmission medium 200 (step S130).

The transmission error detector 310 performs error checking of the Ethernet frame transmitted from the OLT 100 with reference to the FCS2 thereof. The frame disassembler 320 disassembles the encrypted data from the encrypted data, destination address field, source address field, data type/length field and FCS1 of the Ethernet frame, error-checked by the transmission error detector 310. The decrypter 330 decrypts the encrypted data, disassembled from the Ethernet frame by the frame disassembler 320, using a corresponding decryption algorithm and decryption key (step S150). The decrypter 330 outputs the decrypted data, or the original plaintext data prior to the encryption, to the frame reassembler 350.

The frame reassembler 350 reassembles the destination address field, source address field, data type/length field and FCS1 from the frame disassembler 320 and the decrypted data from the decrypter 330 into a reassembled Ethernet frame. The encryption/decryption error detector 370 performs error checking of the reassembled Ethernet frame from the frame reassembler 350 with reference to the FCS1 thereof (step S170).

Encryption/decryption error detector 370 can detect errors having occurred during the encryption and decryption of the data in the Ethernet frame by performing the error checking of the Ethernet frame with reference to the FCS1 thereof.

As apparent from the above description, according to the present invention, a transmitter checks errors of data before and after encrypting the data, respectively, and the receiver checks a transmission error of the received data using an error detection code FCS2, a resultant value of the error checking after the data encryption, and an encryption error and decryption error of the received data using an error detection code FCS1, a resultant value of the error checking before the data encryption. Therefore, it is possible to enhance data error detection performance to more securely transmit and receive data.

Although the embodiments of the present invention have been disclosed for illustrative purposes, those skilled in the art will appreciate that various modifications, additions and substitutions are possible, without departing from the scope and spirit of the invention as disclosed in the accompanying claims.

1. A Gigabit Ethernet passive optical network (GE-PON) comprising:
an optical line terminal (OLT) for performing first error checking of an unencrypted Ethernet frame before encrypting original data content in the Ethernet frame, appending a first error detection code resulting from the first error checking to said Ethernet frame, encrypting said original data content, performing second error checking of the appended Ethernet frame containing the encrypted data, appending a second error detection code resulting from the second error checking to said appended Ethernet frame containing said encrypted data and transmitting the resulting Ethernet frame containing said encrypted data, said first error correction code and said second error correction code to at least one destination; and
at least one optical network terminal (ONT) for checking a transmission error of said received Ethernet frame with said encrypted data, first error correction code and second error correction code transmitted from said OLT using said second error detection code, decrypting said encrypted data and checking an encryption error and decryption error of a resulting Ethernet frame containing the decrypted data using said first error detection code.

2. The GE-PON as set forth in claim 1, wherein said OLT includes:
a first error detector for performing said first error checking of said Ethernet frame and appending said first error detection code to said Ethernet frame, said Ethernet frame being composed of a destination address, a source address, data type/length information and said original data content;
a frame disassembler for disassembling said original data content from said Ethernet frame appended with said first error detection code;
an encrypter for encrypting the disassembled data from said frame disassembler using a predefined encryption algorithm and encryption key;
a frame reassembler for reassembling the encrypted data from said encrypter and said destination address, source address, data type/length information and first error correction code, into a reassembled Ethernet frame; and
a second error detector for performing said second error checking of the reassembled Ethernet frame from said frame reassembler, appending said second error detection code to said reassembled Ethernet frame and transmitting the resulting Ethernet frame to said destination.

3. The GE-PON as set forth in claim 1, wherein said first error detector appends said first error detection code to a tail or a head of said Ethernet frame.

4. The GE-PON as set forth in claim 1, wherein said second error detector appends said second error detection code to a tail or a head of said reassembled Ethernet frame.

5. The GE-PON as set forth in claim 1, wherein said first and second detection codes are appended to a tail of a corresponding Ethernet Frame.

6. The GE-PON as set forth in claim 1, wherein said ONT includes:
a transmission error detector for checking said transmission error of said Ethernet frame containing said encrypted data, said first error correction code and said second error correction code transmitted from said OLT using said second error detection code;
a frame disassembler for disassembling said encrypted data from said transmission error-checked Ethernet frame;
a decrypter for decrypting the disassembled, encrypted data from said frame disassembler using a predefined decryption algorithm and decryption key;
a frame reassembler for reassembling said decrypted data and said transmission error-checked Ethernet frame into a second reassembled Ethernet frame; and
an encryption/decryption error detector for checking said encryption error and decryption error of the second reassembled Ethernet frame from said frame reassembler using said first error detection code.

7. A data error detection method for secure data transmission and reception between one OLT and at least one ONT in a GE-PON structure, comprising the steps of:
a) performing first error checking of an Ethernet frame before encrypting original data content contained in the Ethernet frame, appending a first error detection code resulting from the first error checking to said Ethernet frame, encrypting said original data content, performing second error checking of the appended Ethernet frame containing the encrypted data, appending a second error detection code resulting from the second error checking to said appended Ethernet frame containing said encrypted data and transmitting the resulting Ethernet frame with said encrypted data, said first error correction code and said second error correction code to at least one destination; and
b) checking a transmission error of said Ethernet frame with said encrypted data, first error correction code and second error correction code transmitted from said OLT using said second error detection code, decrypting said encrypted data and checking an encryption error and decryption error of the resulting Ethernet frame with the decrypted data using said first error detection code.

8. The data error detection method as set forth in claim 7, wherein said step a) comprising the steps of:
a-1) performing said first error checking of said Ethernet frame and appending said first error detection code to said Ethernet frame, said Ethernet frame being composed of a destination address, a source address, a data type/length information and said original data content;
a-2) disassembling said original data from said Ethernet frame appended with said first error detection code;
a-3) encrypting the disassembled data using a predefined encryption algorithm and encryption key;
a-4) reassembling the encrypted data and said destination address, said source address, said data type/length information and first error correction code into a reassembled Ethernet frame; and
a-5) performing said second error checking of the reassembled Ethernet frame, appending said second error detection code to said reassembled Ethernet frame and transmitting the resulting Ethernet frame to said destination.

9. The data error detection method as set forth in claim 7, wherein said step b) comprising the steps of:
b-1) checking said transmission error of said Ethernet frame containing said encrypted data, said first error correction code and said second error correction code transmitted from said OLT using said second error detection code;
b-2) disassembling said encrypted data from said transmission error-checked Ethernet frame;
b-3) decrypting the disassembled, encrypted data using a predefined decryption algorithm and decryption key;
b-4) reassembling said decrypted data and said Ethernet frame from which said encrypted data was disassembled; and
b-5) checking said encryption error and decryption error of the reassembled Ethernet frame using said first error detection code.

10. The method as set forth in claim 7, wherein said first error detector appends said first error detection code to a tail or a head of said Ethernet frame.

11. The method as set forth in claim 7, wherein said second error detector appends said second error detection code to a tail or a head of said reassembled Ethernet frame.

12. The method as set forth in claim 7, wherein said first and second detection codes are appended to a tail of a corresponding Ethernet frame.

13. A device comprising:
a first error detector for performing a first error checking of an Ethernet frame containing at least original data content and appending a first error detection code resulting from the first error checking to said Ethernet frame;
a disassembler to isolate said original data content from said appended Ethernet frame;
an encrypter for encrypting said original data content;
a reassembler to reassembly said appended Ethernet frame to contain said encrypted original data content in said appended Ethernet frame; and
a second error detector for performing a second error checking of the appended Ethernet frame containing the encrypted data, and appending a second error detection code resulting from said second error checking to said appended Ethernet frame containing said encrypted data.

14. The device as set forth in claim 13, further comprising:
a transmitter for transmitting the resulting Ethernet frame containing said encrypted data, first error correction code and second error correction code to at least one destination.

15. The device as set forth in claim 13, wherein said first error detector appends said first error detection code to a tail or a head of said Ethernet frame.

16. The device as set forth in claim 13, wherein said second error detector appends said second error detection code to a tail or a head of said reassembled Ethernet frame.

17. The device as set forth in claim 13, wherein said first and second detection codes are appended to a tail of a corresponding Ethernet frame.

18. A device comprising:
a first error detector for checking transmission errors in a received Ethernet frame containing first and second error detection codes appended thereto using said second error detection codes;
a decrypter for decrypting encrypted data content contained in said received Ethernet frame; and
a second error detector for checking encryption errors using said first error detection code.

19. The device as set forth in claim 18, further comprising:
a receiver for receiving said Ethernet frame.

20. The device as set forth in claim 18, further comprising:
a disassembler to isolate said encrypted data from said Ethernet frame; and
a reassembler to reassemble said Ethernet frame with said decrypted data content excluding said second error detection code.

21. The device as set forth in claim 18, wherein said first error detection code is appended to a tail or a head of said Ethernet frame.

22. The device as set forth in claim 18, wherein said second error detection code is appended to a tail or a head of said Ethernet frame.

23. The device as set forth in claim 18, wherein said first and second detection codes are appended to a tail of said Ethernet Frame.
